(19) United States
(12) Patent Application Publication
(10) Pub. No.: US 2009/0279278 A1
(43) Pub. Date: Nov. 12, 2009

(54) Light emitting device and method for manufacturing the same

(75) Inventors: Hiroki Tsujimura, Kyoto (JP); Satoshi Nakagawa, Kyoto (JP)

Correspondence Address: RABIN & Berdo, PC, 1101 14TH STREET, NW, SUITE 500, WASHINGTON, DC, 20005, US

(73) Assignee: ROHM CO., LTD., Kyoto-fu (JP)

(21) Appl. No.: 12/222,125

(22) Filed: Aug. 1, 2008

(30) Foreign Application Priority Data
Aug. 3, 2007 (JP) 2007-202957
Aug. 3, 2007 (JP) 2007-202959
Aug. 3, 2007 (JP) 2007-203017
Aug. 10, 2007 (JP) 2007-209719

(51) Int. Cl. F21V 9/14; H01J 9/24

(52) U.S. Cl. 362/19; 445/23

(57) ABSTRACT

A light emitting device, including: a light emitting element emitting polarized light; and a light emitting element attachment module allowing a polarization direction of the polarized light (incident light) to be set more than −45 degrees and less than +45 degrees with respect to a plane of incidence onto a reflecting surface which reflects the polarized light emitted from the light emitting element.

### CROSS REFERENCE TO RELATED APPLICATIONS AND INCORPORATION BY REFERENCE

This application is based upon and claims the benefit of priority from prior Japanese Patent Application P2007-202957 filed on Aug. 3, 2007, prior Japanese Patent Application P2007-209719 filed on Aug. 10, 2007, prior Japanese Patent Application P2007-202959 filed on Aug. 3, 2007, and prior Japanese Patent Application P2007-203017 filed on Aug. 3, 2007; the entire contents of which are incorporated by reference herein.

### BACKGROUND OF THE INVENTION

1. Field of the Invention

The present invention relates to a light emitting device and specifically relates to a light emitting device capable of controlling the reflectivity of light emitted from a light emitting element and reflected on a reflecting surface.

2. Description of the Related Art

For example, a backlight of a liquid crystal display or the like includes an optical element (a light guide plate) changing the direction that light incoming from a light emitting element propagates to be outputted. The light outputted from the light guide plate is inputted via a polarizing plate into a liquid crystal panel for display of an image on the liquid crystal display. The light incident onto the light guide plate (hereinafter, just referred to as incident light) is dispersed within the light guide plate and then uniformly emitted from the entire light emitting surface for extraction of light. Specifically, the surface of the reflecting surface which reflects the incident light within the light guide plate includes a reflection pattern. The incident light is directed by the reflection pattern and propagates within the light guide plate. The light propagating within the light guide plate is outputted through the light emitting surface.

In recent years, there is a tendency to employ light emitting elements outputting polarized light. In the case of using a light emitting element as a light source of a liquid crystal backlight or a projector, it is expected as described in the following Non-Patent Literature 1 to reduce a component of light cut by the polarizing plate and increase the light emission efficiency.

Non-Patent Literature 1: “Japanese Journal of Applied Physics vol. 39”, P. 413-416, 2000, T. Takeuchi et al.

Recently, there is a tendency to use light emitting diodes (LEDS) in lighting devices including headlights and taillights of vehicles such as automobiles. The light emitting diodes are excellent in reducing power consumption of batteries and are characterized by long life. A light emitting diode generally used is a non-polarized lighting device. Light emitted from such a lighting device causes glistening reflection on wet road surfaces during or after raining or in other cases. Headlights including such light emitting devices reduce lane visibility of a driver of an oncoming vehicle, and taillights including the same reduce the lane visibility of a driver of a following vehicle.

### SUMMARY OF THE INVENTION

The present invention was made to solve the aforementioned problem. The present invention is to provide a light emitting device capable of reducing reflectivity on the reflecting surface. Specifically, the present invention is to provide a light emitting device capable of reducing glistening light reflected on wet road surface.

To solve the aforementioned problem, a light emitting device of the present invention includes a light emitting element emitting light having polarization characteristics; and a light emitting element attachment module, with respect to a plane of incidence onto a reflecting surface which reflects the light emitted from the light emitting element, causing a polarization direction of a P wave of the incident light to be set more than −45 degrees and less than +45 degrees. It is especially preferable that the polarization direction of the P wave is set parallel to the plane of incidence. Furthermore, in the aforementioned light emitting device, the light emitting element may be composed of a group III nitride semiconductor having a non-polar or semi-polar main surface and may include a first semiconductor layer of a first conductive type; a light emitting layer on the first semiconductor layer; and a second semiconductor layer of a second conductive type on the light emitting layer.

The aforementioned light emitting device may be incorporated in a taillight or a headlight of a vehicle. In the aforementioned light emitting device, the reflecting surface may be a screen of a display unit, and the light emitting device may be lighting equipment lighting the screen of the display unit or a light emitting device incorporated in the lighting equipment.

Preferably, a side face is composed of a mirror surface. The substrate is preferably composed of GaN. A main growth surface of the group III nitride semiconductor is preferably m-plane. The substrate preferably has a thickness of not more than 100 μm. The side face preferably has a taper angle to the main growth surface.

The aforementioned light emitting device may further include a light transmitting resin section covering the light emitting element, transmitting the polarized light emitted from the light emitting element, and including resin molecules having a disordered structure. The light transmitting resin section may include the resin molecules randomly located. Moreover, the light transmitting resin section may have a refractivity in a direction vertical to molecular axis of the resin molecules and a refractivity in a direction parallel to the molecular axis, and the two refractivities are equal to each other.

In the light emitting element attachment module of the aforementioned light emitting device, preferably, a part of an inner surface on which the light emitting element is mounted is composed of a mirror surface. It is preferable that the inner surface of the light emitting element attachment module preferably further includes a mounting surface on which the light emitting element is mounted and a reflector reflecting the polarized light emitted from the light emitting element and the mounting surface and the reflector are composed of a mirror surface. Moreover, the mirror surface may be a surface, a roughness of which of the inner surface or the mounting surface and the reflector set to not more than one fourth of wavelength of the polarized light emitted from the light emitting element. Moreover, the mirror surface may be a surface, a roughness of which of the inner surface or the mounting surface and the reflector set to not more than 100 nm. In the light emitting element, a side face may be composed of a mirror surface, and

in a light emitting element attachment module, at least a part of the inner surface on which the light emitting element is mounted may be composed of a mirror surface.

The aforementioned light emitting device may be manufactured by a manufacturing method including the steps of mounting a light emitting element emitting polarized light on a light emitting element attachment module; and dropping and applying light transmitting resin onto the light transmitting element to form a light transmitting resin section covering the light emitting element, the light transmitting resin transmitting polarized light emitted from the light emitting element.

Moreover, the aforementioned light emitting device may be manufactured by a manufacturing method including the steps of mounting a light emitting element emitting polarized light on a light emitting element attachment module; dropping and applying light transmitting resin onto the light transmitting element, the light transmitting resin transmitting polarized light emitted from the light emitting element; and increasing temperature of the light transmitting resin stepwise and hardening the light transmitting resin to form a light transmitting resin section covering the light emitting element.

According to the present invention, it is possible to provide the light emitting device capable of reducing the reflectivity of the reflecting surface.

### BRIEF DESCRIPTION OF DRAWINGS

FIG. 1 is a conceptual view illustrating a system configuration of a light emitting device according to a first embodiment of the present invention.

FIG. 2 is a cross-sectional view of a main portion showing a structure of a light emitting element of the light emitting device shown in FIG. 1.

FIG. 3 is a crystal structure diagram illustrating a non-polar plane of a group III nitride semiconductor of the light emitting element shown in FIG. 2.

FIG. 4 is a crystal structure diagram illustrating an atomic arrangement of the group III nitride semiconductor of the light emitting element shown in FIG. 2.

FIGS. 5A and 5B are crystal structure diagrams illustrating a semi-polar plane of the group III nitride semiconductor of the light emitting element shown in FIG. 2.

FIG. 6 is a view showing a relation between incident polarized light emitted from the light emitting device shown in FIG. 1 and a reflecting surface.

FIG. 7 is a diagram showing a relation between incidence angle of the polarized light emitted from the light emitting device shown in FIG. 1 and incident onto the reflecting surface and reflectivity thereof at the reflecting surface.

FIG. 8 is a conceptual view illustrating applications of the light emitting device shown in FIG. 1 to a taillight and a headlight.

FIG. 9 is a view showing a relation between incident polarized light emitted from the light emitting device shown in FIG. 1 and the reflecting surface.

FIGS. 10A and 10B are schematic views each showing a structure of a light emitting element attachment module to which the light emitting element is assembled in the light emitting device shown in FIG. 1.

FIG. 11 is a conceptual view illustrating a system configuration of a light emitting device according to a second embodiment of the present invention.

FIG. 12A is a cross-sectional view of an structure example of a light emitting element according to a third embodiment of the present invention.

FIG. 12B is a plan view of the example of the light emitting element according to the third embodiment of the present invention.

FIG. 13A-D is a process cross-sectional view illustrating a method of manufacturing the light emitting element according to the third embodiment of the present invention.

FIG. 14 is an electron micrograph of a part including scribed lines.

FIG. 15 is an electron micrograph taken after the part including scribed lines is polished.

FIG. 16A-C is a process cross-sectional view illustrating a method of manufacturing a light emitting element according to a fourth embodiment of the present invention.

FIG. 17A is a plan view showing a method of manufacturing a light emitting element according to a fifth embodiment of the present invention.

FIG. 17B is a cross-sectional view (No. 1) showing the method of manufacturing a light emitting element according to the fifth embodiment of the present invention.

FIG. 18A is a plan view showing the method of manufacturing a light emitting element according to the fifth embodiment of the present invention.

FIG. 18B is a cross-sectional view (No. 2) showing the method of manufacturing a light emitting element according to the fifth embodiment of the present invention.

FIG. 19 is a cross-sectional view (No. 3) showing the method of manufacturing a light emitting element according to the fifth embodiment of the present invention.

FIG. 20 is a cross-sectional view (No. 4) showing the method of manufacturing a light emitting element according to the fifth embodiment of the present invention.

FIG. 21 is a cross-sectional view of a modification of the light emitting element.

FIG. 22 is a configuration view of a light emitting device according to a sixth embodiment of the present invention.

FIG. 23 is a model view of a resin molecule of a light transmitting resin section of the light emitting device shown in FIG. 22.

FIG. 24 is a view showing orientations of resin molecules of the light transmitting resin.

FIG. 25 is a model view showing a case where resin molecules of the light transmitting resin section randomly exist in the light emitting device shown in FIG. 22.

FIG. 26 is a first process cross-sectional view illustrating a method of manufacturing the light emitting device according to the sixth embodiment.

FIG. 27 is a second process cross-sectional view.

FIG. 28 is a third process cross-sectional view.

FIG. 29 is a chart illustrating a way of increasing temperature of the light transmitting resin section of the light emitting device according to the sixth embodiment.

FIG. 30 is a configuration view of a light emitting device according to a seventh embodiment of the present invention.

FIG. 31 is a configuration view of a light emitting device according to an eighth embodiment of the present invention.

FIG. 32 is a configuration view of a light emitting device according to a ninth embodiment of the present invention.

### DETAILED DESCRIPTION OF THE INVENTION

Next, a description is given of embodiments of the present invention with reference to the drawings. In the following description of the drawings, the same or similar numerals and symbols are applied to the same or similar parts. The drawings are schematic representations and are different from actual ones. Some parts are different in dimensional relationship and proportions throughout the drawings. The following embodiments are intended to illustrate devices and methods embodying the technical idea of the present invention by examples, and the technical idea of the present invention does not specify the arrangement of components and the like. The technical idea of the present invention can be variously modified within the scope of claims.

### First Embodiment

In a first embodiment of the present invention, a description is given of an application of the present invention to light emitting devices assembled to taillights and headlights of vehicles including automobiles.

### [System Configuration of Light Emitting Device]

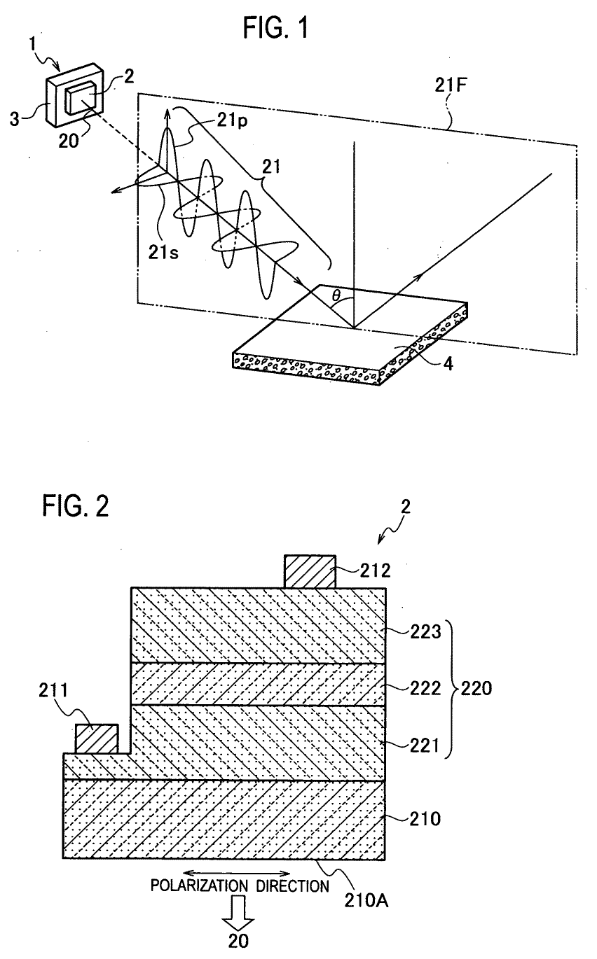

As shown in FIG. 1, a light emitting device 1 according to the first embodiment includes a light emitting element 2 emitting light 20 having polarization characteristics (hereinafter, just referred to as polarized light); and a light emitting element attachment module 3. The light emitting element attachment module 3 sets the polarization direction of the incident light 21 more than −45 degrees and less than 45 degrees with respect to a plane 21F of incidence onto a reflecting surface 4 which reflects the polarized light 20 emitted from the light emitting element 20 as incident light 21.

### [Configuration of Light Emitting Element]

For example, as shown in FIG. 2, the light emitting element 2 of the first embodiment includes a light emitting section 220 producing the polarized light 20; and an output section (substrate) 210 on which the light emitting section 220 is mounted and which outputs the polarized light 20 emitted from the light emitting section 20. Herein, the “polarized light” means light with linear polarization components being biased and not equal (random). However, in the first embodiment, the polarized light is not necessary 100% linearly polarized light. Accordingly, the polarization direction of the polarized light 20 is a direction of the largest liner polarized component.

The light emitting section 220 is formed by using a non-polar or semi-polar plane of a GaN crystal as a crystal growth surface and sequentially stacking a first semiconductor layer 221 of a first conduction type, a light emitting layer 222, and a second semiconductor layer 223 of a second conduction type in a normal direction of the crystal growth surface. For example, if the crystal growth surface is non-polar m-plane, the light emitting element 2 is composed of a group III nitride semiconductor whose main surface is m-plane. Examples of the group III nitride semiconductor are aluminum nitride (AlN), gallium nitride (GaN), indium nitride (InN), and the like. A typical one of the group III nitride semiconductors is expressed by AlₓIn_{y}Ga_{1-x-y}N (0<=x<=1, 0<=y<=1, 0<=x+y<=1). The GaN semiconductors are group III-V semiconductors well known among hexagonal crystal compound semiconductor compound containing nitrogen.

The light emitting layer 222 is supplied with carriers of the first conduction type from the first semiconductor layer 221 and is supplied with carriers of the second conduction type from the second semiconductor layer 223. When the first and second conduction types are n type and p type, respectively, electrons supplied from the first semiconductor layer 221 and holes supplied from the second semiconductor layer 223 are recombined in the light emitting layer 222 to emit the polarized light 20 from the light emitting layer 222. The light emitting layer 222 can have, for example, a quantum well structure in which a well layer is sandwiched between barrier layers (layer barrier layers) having band gaps larger than that of the well layer. Such quantum well structures include a quantum well structure including not a single well layer but multiplexed well layers and further include a quantum well structure in which the light emitting layer 222 has a multiple quantum well (MQW) structure.

Usually, light extracted from a light emitting layer composed of a group III nitride semiconductor with the crystal growth surface being polar c-plane of a GaN crystal is randomly polarized (not polarized). On the other hand, light extracted from the light emitting layer composed of a group III nitride semiconductor whose crystal growth surface is a non-polar or semi-polar plane such as the a- or m-plane other than the c-plane can be strongly polarized. For example, when the main surface of the light emitting layer 222 is the m-plane, the polarized light 20 emitted from the light emitting layer 222 can contain a polarization component parallel to the m-plane, more concretely, a polarization component in the direction of the axis a. The non-polar plane and semi-polar plane are described in detail later.

The light emitting section 220 is grown on the crystal growth surface of the output section 210 by crystal growth. Specifically, as shown in FIG. 2, the light emitting element 2 includes the output section 210, the first semiconductor layer 221 on the output section 210, the light emitting layer 222 on the first semiconductor layer 221, and the second semiconductor layer 223 on the light emitting layer 222. In the first embodiment, the output section 210 is composed of for example a GaN single crystal substrate. When the main surface of the output section 2, which serves as the crystal growth surface, is the non-polar m plane, the light emitting section 220 can be formed on this main surface by crystal growth. In other words, the light emitting section 220 is composed of GaN whose crystal growth surface is the m-plane, and the light emitting element 2 is composed of a group III nitride semiconductor grown with the crystal growth surface being the m-plane. The main surface of the output section 210 is the same as that of the light emitting section 220.

The light emitting element 2 includes a first electrode 211 supplying operating voltage to the first semiconductor layer 221 and a second electrode 212 supplying operating voltage to the second semiconductor layer 223. As shown in FIG. 2, parts of the second semiconductor layer 223, light emitting layer 222, and first semiconductor layer 221 are removed by mesa etching, and the first electrode 211 is provided on the exposed surface of the first semiconductor layer 221. The first semiconductor layer 221 and first electrode 211 are electrically connected. The second electrode 212 is provided on the second semiconductor layer 223. The second semiconductor layer 223 and second electrode 212 are electrically connected.

The first electrode 211 is made of aluminum (Al), for example, and the second electrode 212 is made of palladium (Pd)-gold (Au) alloy, for example. The first electrode 211 is ohmically connected to the first semiconductor layer 211, and the second electrode 212 is ohmically connected to the second semiconductor layer 233. Between the first semiconductor layer 221 and first electrode 211, a contact layer of the first conduction type may be interposed. Moreover, between the second semiconductor layer 223 and second electrode 212, a contact layer of the second conduction type may be interposed.

In the light emitting element 2, the surface (rear surface) of the output section 210 which is in contact with the first semiconductor layer 221 and opposite to the crystal growth surface (main or front surface) is an output surface 210A. The polarized light 20 emitted from the light emitting layer 222 is outputted through the output surface 210A to the outside of the light emitting element 2 as output light. The light emitting element 2 according to the first embodiment is electrically connected to an electrode (not shown) of the light emitting element attachment module 3 through a bump electrode and mounted by the flip-chip technique.

### [Crystal Structure of Light Emitting Element]

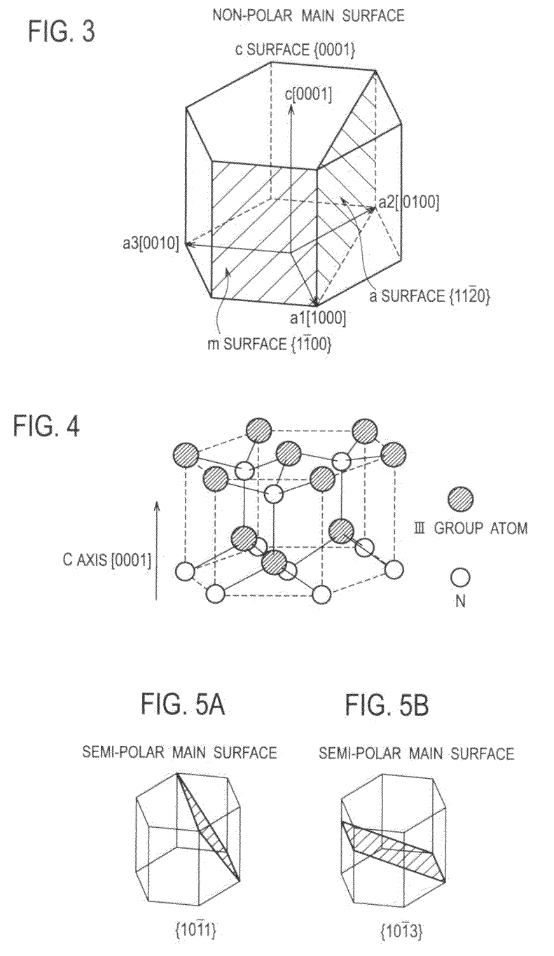

The crystal structure of a unit cell of the group III nitride semiconductor constituting the light emitting element 2 can be approximated by a hexagonal crystalline structure as shown in FIGS. 3 and 4. In the hexagonal crystal structure, the c axis is along the axial direction of a hexagonal prism. A plane whose normal line is the c axis (a top face of the hexagonal prism) is the c-plane {0001}. Cleaving a crystal of the grope III nitride semiconductor at two planes parallel to the c-plane {0001}, the surface on the +c side (+c face) is a crystal face where group III atoms are arranged. The surface on the −c side (−c face) is a crystal face where nitrogen atoms are arranged. The c-plane therefore has different natures between on the +c side and −c side and is therefore called a polar plane.

As shown in FIG. 4, a single group III atom is bonded to four nitrogen atoms. The four nitrogen atoms are located at four vertices of a regular tetrahedron with the III group atom located at the center. One of the four nitrogen atoms is located on the +c side of the group III atom, and the other three nitrogen atoms are located on the −c side of the group III atom. Because of such a crystal structure, the polarization direction of the group III nitride semiconductor is along the c axis.

In the hexagonal crystal structure, each side face of the hexagonal prism is the m plane {1-100}. Planes each including a pair of ridges not adjacent to each other are the a-plane {11-20}. The m- and a-planes are crystal faces which are at right angles to the c-plane and are perpendicular to the polarization direction. The m- and a-planes are planes having no polarity, that is, non-polar planes. Moreover, crystal faces tilted with respect to the c-plane (not parallel and not perpendicular to the c-plane) diagonally crosses the polarization direction and is a plane having slight polarity, that is, a semi-polar plane. Concrete examples of the semi-polar plane are {10-11} plane shown in FIG. 5A, {10-13} plane shown in FIG. 5B, and the like.

### [Reflection Characteristics of Polarized Light]

As shown in FIG. 1, the polarized light 20 emitted from the light emitting element 2 of the light emitting device 1 according to the first embodiment is incident onto the reflecting surface 4 as the incident light 21 including two types of components with different polarization directions, a P wave 21p and an S wave 21s and then reflected on the surface of the reflecting surface 4. The P wave 21p is a component of the polarized light 21 parallel to the plane 21F of incidence, and the S wave 21s is a component of the incident light 21 vertical to the plane 21F of incidence. Herein, the plane 21F of incidence is a plane including an incident light axis of the incident light 21 and the surface normal of the reflecting surface 4 as virtually shown in FIG. 1.

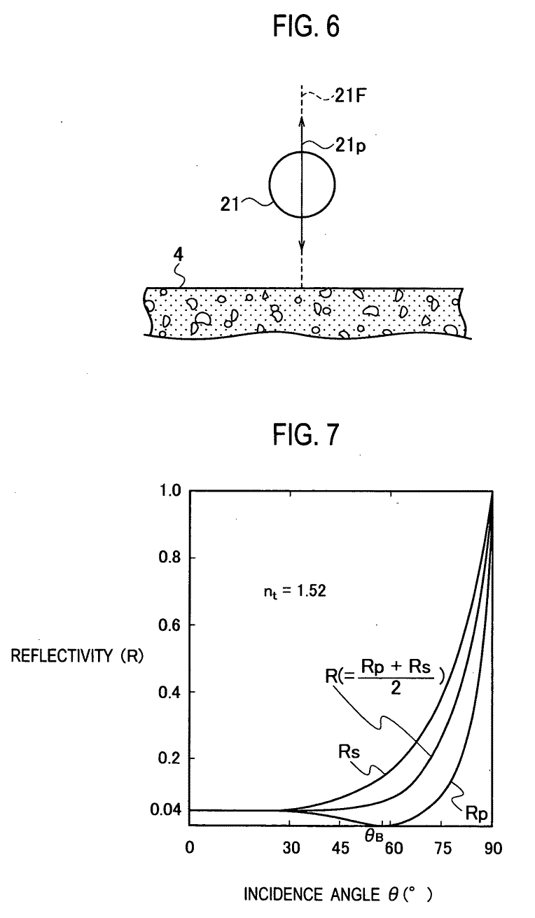

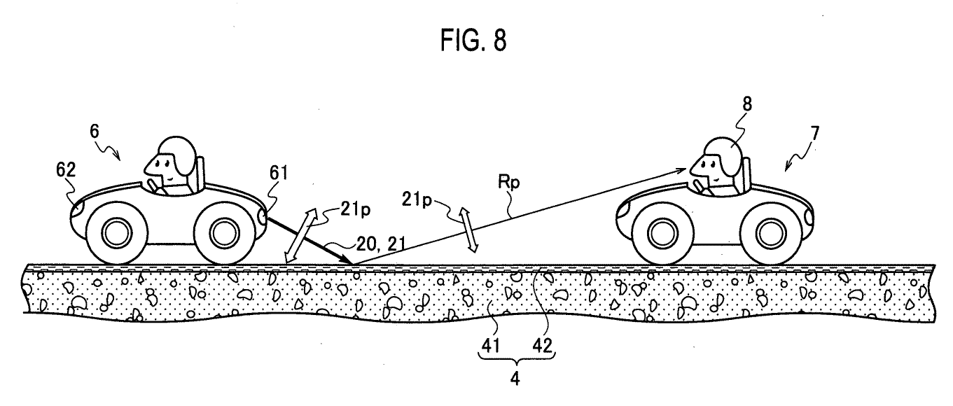

In the light emitting device 1, the incident light 21 of the polarized right 20 emitted from the light emitting element 2 is set by the light emitting element attachment module 3 so that the polarization direction of the P wave 21p is parallel to the plane 21F of incidence as shown in FIG. 6. The P wave 21p of the incident light thus oscillates at right angles to the reflecting surface 4.

The relation between the incidence angle of the incident light 21 onto the reflecting surface 4 and the reflectivity is shown in FIG. 7. In the drawing, the horizontal axis indicates an incidence angle θ between the incident light axis and the surface normal of the reflecting surface 4, and the vertical axis indicates reflectivity R. Herein, the refractive index nₜ is for example 1.52. The reflectivity R of the incident light 21 is expressed by the following expression.

R=(Reflectivity Rp+Reflectivity Rs)/2

The reflectivity Rp is a reflectivity of the P wave 21p of the incident light 21 incident onto the reflecting surface 4. The reflectivity Rs is a reflectivity of the S wave 21s of the incident light 21 incident onto the reflecting surface 4. In a range of the incidence angle θ from about 30 to 90 degrees, the reflectivity Rs of the S wave 21s is larger than that of the incident light 21. On the other hand, in the same angular range, the reflectivity Rp of the P wave 21p is smaller than that of the incident light 21.

In the light emitting device 1 according to the first embodiment, by using the property that the reflectivity Rp of the P wave 21p of the polarized light 20 emitted from the light emitting element 2 is small, the light emitting device 1 is built in a taillight 61 of a vehicle 6 such as an automobile or the like so as to reduce the reflectivity of the polarized light 20 emitted from the light emitting device 1 on the reflecting surface 4. On the reflecting surface 4, specifically, on a road surface 41 where water 42 exists, that is, a so-called wet road surface 41, glistening reflection can be reduced, thus improving the lane visibility from a driver 8 of a following vehicle 7.

Moreover, the light emitting device 1 according to the first embodiment can be built in a headlight 62 of a vehicle 6. In this case, the glistening reflection on the wet road surface 41 can be also reduced. Accordingly, the lane visibility of a driver of an oncoming vehicle (not shown) can be increased. It is therefore possible to implement the light emitting device 1 capable of increasing safety in the rain and the like.

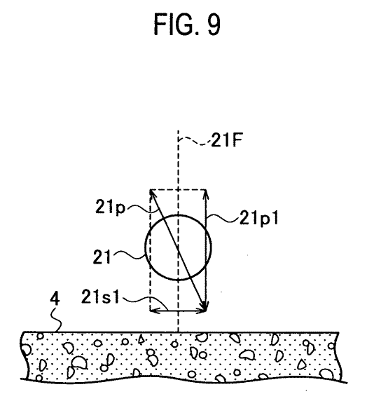

As shown in FIG. 9, even when the polarization direction of the incident light 21 is slightly tilted to the incidence plane 21F, the light emitting device 1 according to the first embodiment can reduce the reflectivity Rp of the P wave 21p. The P wave 21p whose polarization direction is tilted can be resolved into a P wave component 21p1 parallel to the incidence plane 21F and an S wave component 21s1 perpendicular to the incidence plane 21F. The latter S wave component 21s1 is a reflection component causing glistening. When the P wave component 21p1 is larger than the S wave component 21s1, the P wave component 21p1 is dominant, and the reflectivity Rp can be reduced. Specifically, if the polarization direction of the incident light 21 is set to a tilt |θ_{A}| of more than −45° and less than 45° to the incident plane 21F, the reflectivity Rp of the P wave 21p can be reduced compared to natural light.

Furthermore, as shown in FIG. 7 described above, the reflectivity Rp of the P wave 21p of the incident light 21 becomes zero at an incidence angle θ_{B}. In other words, at the incident angle θ_{B}, no effective glistening reflection occurs on the wet road surface 41. In the first embodiment, the incident angle θ_{B} which reduces the reflectivity Rp to substantially zero is in a range of 53 to 60 degrees. In the first embodiment, if the incidence angle θ of the P wave 21p of the incidence light 21 is in a range of 45 to 75 degrees, the reflectivity of Rp can be reduced to half the reflectivity R of the incident light 21 itself, and the reflectivity can be considerably reduced. In the first embodiment, accordingly, by setting the polarization direction of the incident light 21 emitted from the light emitting element 2 parallel to the plane 21F of incidence, the glistening reflection on the wet road surface 41 can be considerably reduced.

### [Configuration of Light Emitting Element Attachment Module]

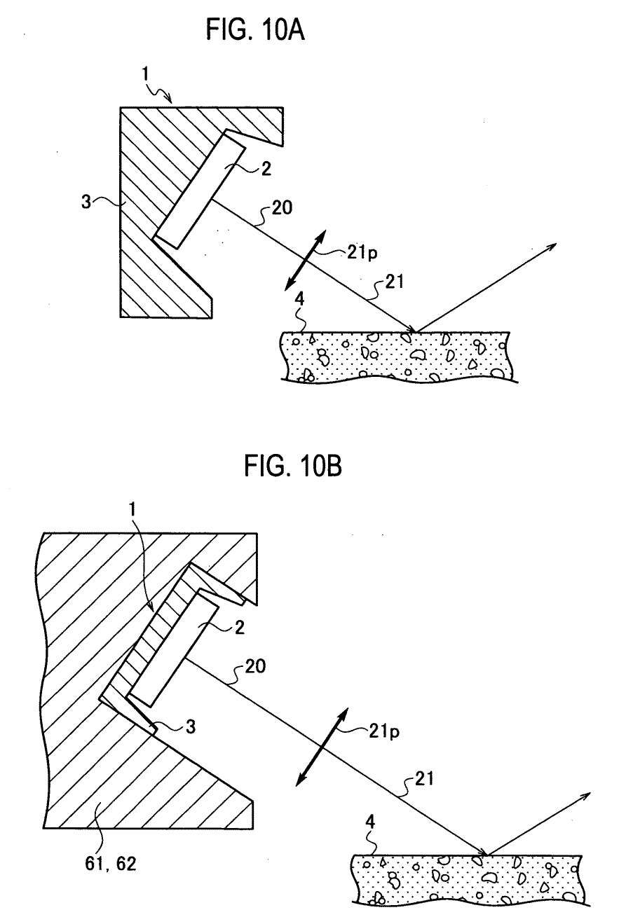

As shown in FIG. 10A, in the light emitting element attachment module 3, the light emitting element 2 is assembled to the inside of the body in such a manner that the polarization direction of the incident light 21 emitted therefrom is adjusted to be parallel to the plane F of incidence onto the reflecting surface 4 (or perpendicular to the reflecting surface 4) and the incidence angle θ of the P wave 21p is adjusted so that the reflectivity Rp is zero. In the first embodiment, as described above, the light emitting element 2 can be assembled to the inside of the body of the light emitting element attachment module 3 in such a manner that the polarization direction of the incident light 21 is adjusted to a tilt of more than −45 degrees and less than 45 degrees to the plane 21F incidence onto the reflecting surface 4.

In the first embodiment, as shown in FIG. 10B, the light emitting element 2 may be assembled to the light emitting element attachment module 3 so that the polarization direction of the incident light emitted therefrom is not parallel to the plane 21F of incidence onto the reflecting surface 4. In this case, the polarization direction of the incident light 21 emitted from the light emitting element 2 of the light emitting element attachment module 3 is adjusted to be parallel to the plane 21F of incidence onto the reflecting surface 4 when the light emitting element attachment module 3 is assembled to the taillight (unit) 61 or headlight (unit) 62.

As described above, according to the first embodiment, it is possible to provide the light emitting device 1 capable of reducing the reflectivity R at the reflecting surface 4. In the first embodiment, in particular, it is possible to provide the light emitting device 1 capable of reducing glistening reflection on the wet road surface 41. Moreover, the configuration of the light emitting element 2 of the light emitting device 1 is not limited to this, and for example, the first electrode 211 may be provided so as to be in contact with the GaN single crystal substrate as the output section 210 (on the other side of the first semiconductor layer 221).

### Second Embodiment

A second embodiment of the present invention describes an application of the light emitting device 1 according to the first embodiment included in interior lighting equipment.

### [System Configuration of Light Emitting Device]

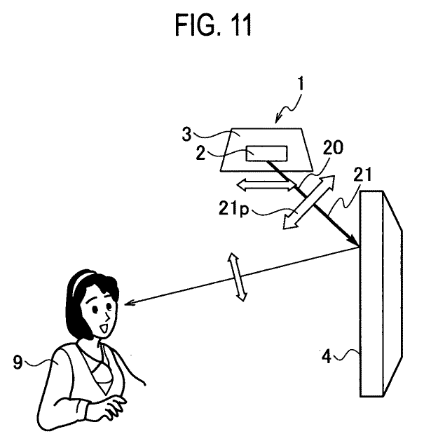

As shown in FIG. 11, a light emitting device 1 according to the second embodiment is used for interior lighting equipment. Specifically, the light emitting device 1 includes a light emitting element 2 emitting the polarized light 20 and a light emitting element attachment module 3. The light emitting element attachment module 3 causes the polarization direction of the incident light 21 to be set more than −45 degrees and less than 45 degrees and preferably set parallel to the plane 21F of incidence onto the reflecting surface 4 (see FIG. 1), which reflects the polarized light 20 emitted from the light emitting element 2.

Herein, the reflecting surface 4 is a screen of a display unit, and the light emitting device 1 is used as interior lighting equipment illuminating the screen of the display unit. Examples of the display unit include CRT display units, liquid crystal display units, plasma display units, organic electroluminescence display units, and the like. Such display units are used as televisions and monitors of personal computers.

Specifically, in the light emitting device (interior lighting equipment) 1 according to the second embodiment, the polarization direction of the incident light 21 emitted from the light emitting element 2 is adjusted to be parallel to the plane 21F of incidence onto the reflecting surface 4. As described above, in the light emitting device 1, the polarization direction is adjusted to a tilt of more than −45 degrees and less than 45 degrees to the plane 21F of incidence onto the reflecting surface 4. This can reduce the reflectivity Rp of the P wave 21p of the incidence light 21 at the reflecting surface 4. Accordingly, the glistening reflection on the reflecting surface 4 (the screen of the display unit) can be reduced. A user 9 can therefore see the screen of the display unit with less reflection due to the interior lighting equipment.

According to the second embodiment, as described above, it is possible to provide the light emitting device 1 capable of reducing the reflectivity R at the reflecting surface 4. In the light emitting device 1 according to the second embodiment, in particular, glistening light on the screen of the display unit can be reduced. The light emitting device 1 is not limited to use in the interior lighting equipment and can be used for outdoor (field) lighting equipment.

Moreover, the present invention is not limited to such applications and can be applied to the light emitting device emitting polarized light towards road signs, traffic lights, and the like which get difficult to see because of glistening reflection on wet reflecting surfaces wetted by bad weather such as raining, for example.

### Third Embodiment

Next, with reference to the drawings, a description is given of a third embodiment including a modification of the light emitting element of the aforementioned light emitting device.

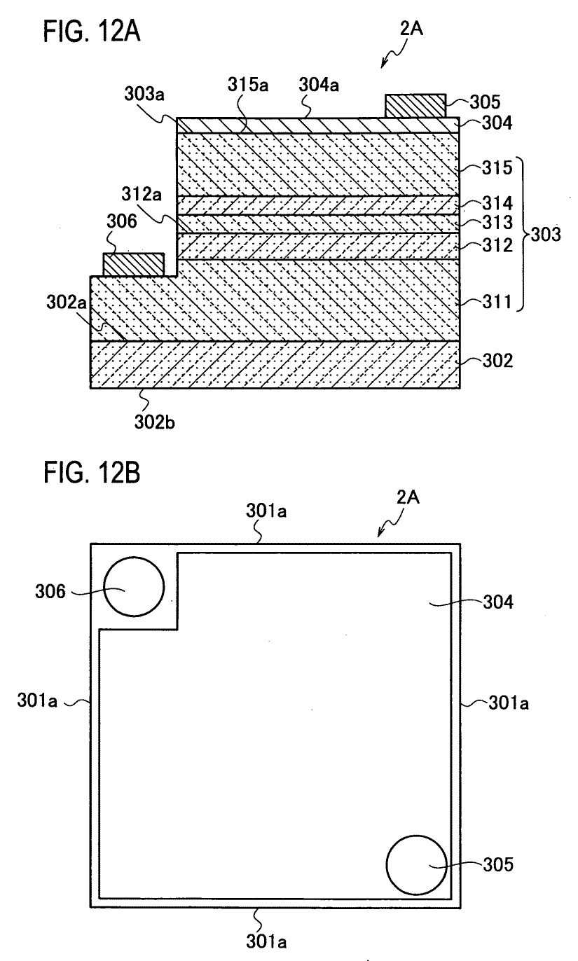

As shown in FIGS. 12A and 12B, a light emitting element 2A according to the third embodiment of the present invention includes a substrate 302; and a light emitting section 303 which includes a light emitting layer 312 composed of a group III nitride semiconductor in which a main growth surface 312a is a non-polar or semi-polar plane and emits polarized light from the light emitting layer 312. A side face 301a of the light emitting element 2A is a mirror surface. The side face 301a is composed of a surface adjacent to a surface 302a of the substrate 302 and a surface 303a of the light emitting section 303. Herein, the “mirror surface” is a surface whose roughness is not more than wavelength of light emitted from the light emitting layer 312. Furthermore, the light emitting element 2A according to the third embodiment includes a first electrode section (anode electrode) 304, a connecting section 305, and a second electrode (cathode electrode) 306.

The substrate 302 is composed of a conductive n-type GaN which has a hexagonal crystal structure and is doped with silicon as an n-type dopant. Preferably, the substrate 302 has such a thickness that the substrate 302 can be cleaved in a manufacturing process. Specifically, it is preferable that the thickness of the substrate 302 is not more than about 100 μm. The surface constituting the side face 301a adjacent to the surface 302a among the surfaces of the substrate 302 is the mirror surface. As an example, the surface constituting the side face 301a adjacent to the surface 302a among the surfaces of the substrate 302 is mirror finished so that the roughness thereof is not more than about 100 nm.

The surface 302a of the substrate 302 is a face for epitaxial growth of the light emitting section 303 and is composed of the non-polar m-plane.

The light emitting section 303 is formed by epitaxial growth of the group III nitride semiconductor having the hexagonal crystal structure on the surface 302a of the substrate 302. The light emitting section 303 includes a first semiconductor layer (n-type contact layer) 311, a light emitting layer 312, a final barrier layer 313, a p-type electron blocking layer 314, and a second semiconductor layer (p-type contact layer) 315 which are sequentially stacked on each other from the substrate 302 side. Herein, since the surface 302a of the substrate 302 is composed of the m-plane as described above, a surface 303a of the light emitting section 303 layered on the surface 302a of the substrate 302 and a growth surface 312a of the light emitting layer 312 are also the non-polar m-plane through which light polarized in the light emitting layer 312 is emitted.

The first semiconductor layer 311 is composed of an n-type GaN layer doped with silicon having a concentration of about 1×10¹⁸ cm⁻³ as an n-type dopant and has a thickness of not less than about 3 μm.

The light emitting layer 312 has a quantum well structure including five pairs of about 3 nm thick In_{z}Ga_{1-z}N layers doped with silicon and about 9 nm thick GaN layers which are alternately stacked on each other. This light emitting layer 312 emits blue light (for example, having a wavelength of about 430 nm). Herein, Z, which is a ratio of In to Ga in each In_{z}Ga_{1-z}N layer, is set 0.05<=Z<=0.2. To cause the light emitting layer 312 to emit green light, Z is set Z>=0.2.

The final barrier layer 313 is composed of an about 40 nm thick GaN layer. The doping type thereof may be either p-type doping, n-type doping, or non-doping but preferably non-doping.

The p-type electron blocking layer 314 is composed of an about 28 nm thick AlGaN layer doped with magnesium having a concentration of about 3×10¹⁹ cm⁻³ as a p-type dopant.

The second semiconductor layer 315 is composed of an about 70 nm thick p-type GaN layer doped with magnesium having a concentration of about 1×10²⁰ cm⁻³ as a p-type dopant. A light extraction surface 315a of the second semiconductor layer 315 is for extraction of light emitted from the light emitting layer 312 from the light emitting section 303. The surface of the light extraction surface 315 is preferably a mirror surface with a roughness of not more than about 100 nm in order to reduce dispersion of light for preventing reduction in polarization ratio. The light extraction surface 315a is the same as the surface 303a of the light emitting section 303.

The first electrode section 304 is composed of light transmissive ZnO. The first electrode section 304 is ohmically connected to the second semiconductor layer 315 and is formed so as to cover substantially the entire upper surface of the second semiconductor layer 315 in order to allow current to flow the entire area of the light emitting section uniformly in the horizontal direction (in the direction perpendicular to the stacking direction). The first electrode section 304 has such a thickness of about 200 to 300 nm that light emitted from the light emitting layer 312 can be transmitted. A light extraction surface 304a of the first electrode section 304 is a surface for extraction of the light emitted from the light emitting layer 312 and is preferably mirror-finished so that the roughness of the surface is not more than 100 nm like the light extraction surface 315a of the second semiconductor layer 315. For example, the mirror surface described above can be obtained by using electron beam deposition. In such a manner, by the mirror-finished light extraction surfaces 315a and 304a, the light emitted from the light emitting layer is prevented from dispersion and is therefore extracted with the polarization ratio maintained high. On a part of the first electrode section 304, a connecting section 305 including a titanium (Ti) layer and an Au layer stacked is provided.

The second electrode 306 includes Ti and aluminum (Al) layers stacked on each other. The second electrode 306 is formed on an exposed area of an upper surface of the first semiconductor layer 311 in contact with the same.

Next, a description is given of an operation of the light emitting element 2A according to the aforementioned third embodiment. Upon application of forwarding voltage, the light emitting element 2A is supplied with holes from the first electrode section 304 and is supplied with electrons from the second electrode 306. The electrons are injected through the first semiconductor layer 311 to the light emitting layer 312 while the holes are injected through the semiconductor layers 313 to 315 to the light emitting layer 312. The electrons and holes injected to the light emitting layer 312 are recombined to emit light with a peak wavelength of about 430 nm. Herein, since the surface 303a of the light emitting section 303 is the non-polar m-plane, the light emitted from the light emitting layer 312 is polarized.

Light traveling towards the first electrode section 304 among the light emitted from the light emitting layer 312 is transmitted through the first electrode section 304 to be projected to the outside. Moreover, light traveling towards the substrate 302 among the light emitted from the light emitting layer 312 is transmitted through the first semiconductor layer 311 and substrate 302 and reaches a rear surface 302b of the substrate 302. A part of the light is reflected on the rear surface 302b of the substrate 302 towards the first electrode section 304, and another part of the light is transmitted through the rear surface 302b and projected to the outside. Light traveling towards the side face 301a among the light emitted from the light emitting layer 312 is projected to the outside from the side face 301a. Since the side face 301a is a mirror-finished surface, the light projected to the outside through the side face 301a can be prevented from being diffusely reflected by a rough surface and can be kept polarized. It is therefore possible to extract light with a high polarization ratio to the outside.

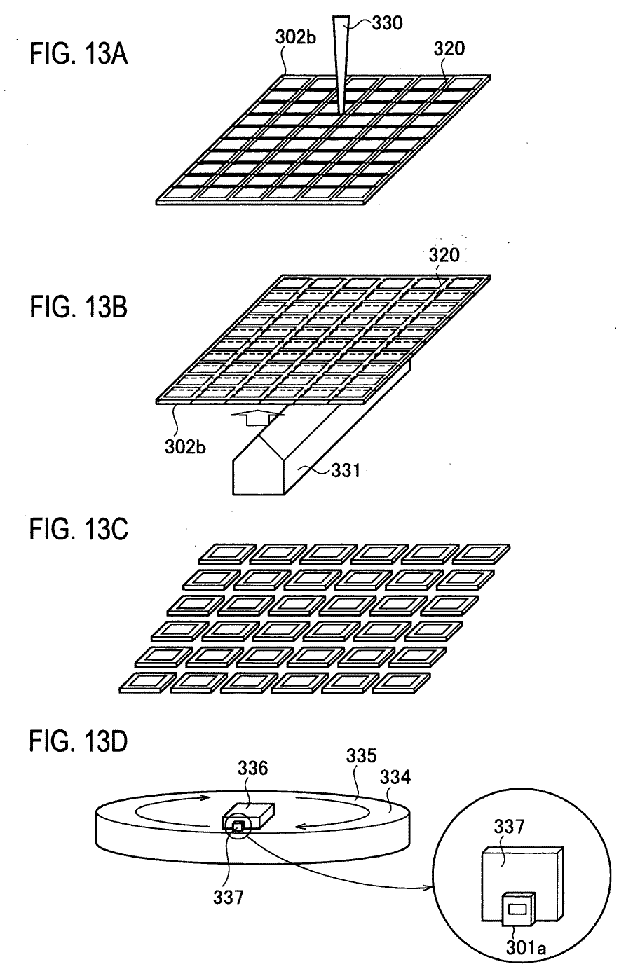

A description is given of a method of manufacturing the light emitting element 2A according to the third embodiment below with reference to FIG. 13.

First, the substrate 302 composed of a single crystal of GaN and having a thickness of about 300 μm. The surface 302a of the substrate 302 is the non-polar m-plane. Herein, the substrate 302 whose surface 302a is the m-plane is cut out from the GaN single crystal whose main surface is the c-plane and then polished by chemical mechanical polishing (CMP) so that both orientation errors in the (0001) and (11-20) directions are within ±1 degree preferably within ±1 degree and preferably ±0.3 degrees. It is therefore possible to obtain the substrate 302 which has little crystal defects such as dislocation and stacking faults and has roughness of the surface 302a reduced to the atomic level.

Next, the light emitting section 303 is epitaxially grown on the surface 302a of the aforementioned substrate 302 by metal organic vapor phase deposition (MOCVD). Specifically, the substrate 302 is introduced to a processing chamber of an MOCVD machine (not shown) and is placed on a heatable and rotatable susceptor. The processing chamber has an atmosphere exhausted so as to be 1/10 atm to normal pressure.

Next, to reduce the roughness of the surface 302a of the substrate 302, ammonium gas is supplied to the processing chamber with carrier gas (H₂ gas) while the temperature of the substrate 302 is raised to about 1000 to 1100° C. Herein, since the substrate 302 is about 300 μm thick, deformation of the substrate 302 due the above the temperature can be prevented.

Subsequently, ammonium gas, trimethylgallium (TMG) gas, and silane are supplied to the processing chamber with carrier gas to epitaxially grow the first semiconductor layer 311 composed of the n-type GaN layer doped with silicon on the surface 302a of the substrate 302.

After the temperature of the substrate 302 is set to about 700 to 800° C., the light emitting layer 312 is formed on the first semiconductor layer 311. Specifically, ammonium gas and TMG gas are supplied to the processing chamber with carrier gas to epitaxially grow a barrier layer composed of a non-doped GaN layer (not shown). Moreover, with the temperature of the substrate 302 being maintained at constant temperature, ammonium gas, TMG gas, trimethylindium (TMI) gas, and silane gas are supplied to the processing chamber with carrier gas for epitaxial growth of a well layer (not shown) composed of an n-type InGaN layer doped with silicon. The aforementioned methods are alternately repeated for desired times to form the barrier and well layers, thus forming the light emitting layer 312. Thereafter, ammonium gas and trimethylgallium gas are supplied to the processing chamber with a carrier gas to grow the final barrier layer 313 composed of a GaN layer.

After the temperature of the substrate 302 is raised to about 1000 to 1100° C., ammonium gas, TMG gas, trimethylaluminum (TMA) gas, and bis(cyclopentadienyl)magnesium (Cp₂Mg) gas with carrier gas for epitaxial growth of the p-type electron blocking layer 314 composed of a p-type AlGaN layer doped with magnesium on the final barrier layer 313.

With the temperature of the substrate 302 being maintained at about 1000 to 1100° C., ammonium gas, TMG gas, and Cp₂Mg gas are supplied to the processing chamber with carrier gas for epitaxial growth of the second semiconductor layer 314 composed of a p-type GaN layer doped with magnesium on the p-type electron blocking layer 314. Each of the growth surface 312a of the light emitting layer 312 and the main surfaces of the first semiconductor layer 311, final barrier layer 313, and p-type electron blocking layer 314 is thus formed into the non-polar m-plane.

Subsequently, the first electrode section 304 composed of ZnO is formed on the entire surface 315a of the second semiconductor layer 315 by sputtering or vacuum vapor deposition.

By forming a desired resist pattern and etching the first electrode section 304 and light emitting section 303, a part of the semiconductor layer 311 is mesa-etched to expose the surface of the electrode. In the exposed surface of the electrode, Ti and Al layers are sequentially stacked by vacuum vapor deposition such as resistance heating deposition or electron beam deposition to form the second electrode 306. The connecting section 305 is formed after the first electrode section 304 is formed and may be formed either before or after the second electrode 306 is formed. When the connecting section 306 has the same composition as that of the second electrode 306, the connecting section 306 may be formed simultaneously with the second electrode 306.

Subsequently, a part of the substrate 302 on the rear surface 302b side is ground by mechanical polishing so that the thickness of the substrate 302 is not more than about 100 μm.

As shown in FIG. 13A, then, the rear surface 302b of the substrate 302 is ground to provide guide lines 320 for element division using a scriber 330 made of diamond or the like. After the guide lines 320 are formed in the rear surface 302b of the substrate 302, stress is applied to part of the substrate 302 where the lines 320 are formed using a breaker 331 made of ceramic or the like. By applying stress to the part where the lines 320 are formed, as shown in FIG. 13C, the manufactured product can be divided into individual element units.

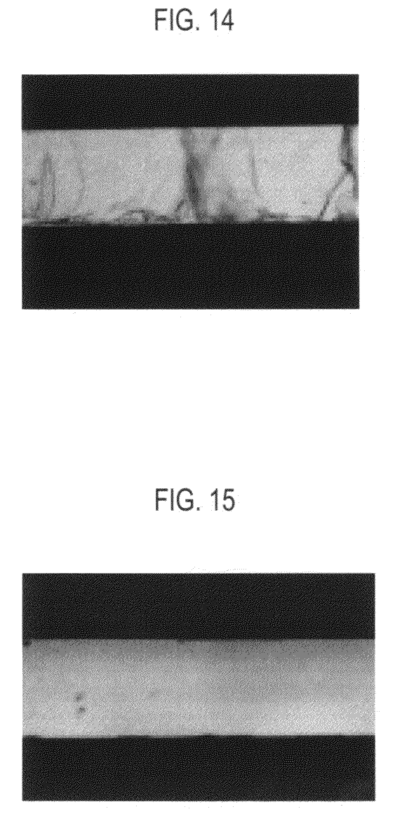

In the side face 301a formed by the division, the c-plane is the cleaved surface and is a mirror surface, but the a-plane is not the cleaved surface and is rough. The part of the side face 301a of the substrate 302 where the lines 320 are formed are also rough as shown in an electron micrograph of FIG. 14. Accordingly, the rough part of the side face 301a of the substrate 302 due to the guide lines 320 is polished and mirror-finished. Since the substrate 302 is as thin as about 100 μm, each divided element is attached to a dummy substrate 337, and the dummy substrate 337 with the device attached thereto is placed on a jig 336. The side face 301a of the substrate 302 is polished by a polisher 335 using an abrasive sheet 334 for mirror finishing of the side face 301a. When the abrasive sheet 334 has a roughness of about 100 nm, the side face 301a of the substrate 302 is allowed to have a roughness of about 100 nm. The polished side face 301a of the substrate 302, which is rough at first, is polished into a mirror surface as shown in an electron micrograph of FIG. 15. Through the aforementioned process, the light emitting element 2A according to the third embodiment is completed.

In the aforementioned step of polishing the side face 301a, the abrasive sheet 334 is used. However, the polishing may be performed by CMP or by a combination of the abrasive sheet and CMP.

According to the light emitting element 2A according to the third embodiment of the present invention, the entire side face 301a is configured to be the mirror surface. Accordingly, light projected from the entire surface of the side face 301a to the outside like LEDs can be prevented from being diffusively reflected by the rough surface and can be maintained to be polarized. This makes it possible to extract light with a high polarization ratio to the outside.

Moreover, in the light emitting element 2A according to the third embodiment of the present invention, the substrate 302 is composed of conductive GaN. Accordingly, light emitting section 303 can be configured to have little stacking faults and have high crystallinity. The light emission efficiency can be thus increased.

Moreover, in the light emitting element 2A according to the third embodiment, the surface 302a of the substrate 302 is composed of the non-polar m-plane, thus preventing polarization of the growth surface of the light emitting section 303 at the crystal growth. The light emitting section 303 can be therefore grown on the stable growth surface, thus increasing the crystallinity of the light emitting section 303. This can increase the light emission efficiency of the light emitting layer 312 and also increase the polarization ratio of the light.

Moreover, in the light emitting element 2A according to the third embodiment of the present invention, the substrate 302 is ground before the division into the element units so that the thickness of the substrate 302 is not more than about 100 μm. Accordingly, the substrate 302 can be cleaved. The light emitting element 2A can be easily divided into the element units. The configuration of the light emitting element 2A is not limited to this embodiment, and the second electrode 306 may be provided so as to be in contact with the substrate 302 composed of a single crystal of GaN (on the opposite side to the first semiconductor layer 311).

### Fourth Embodiment

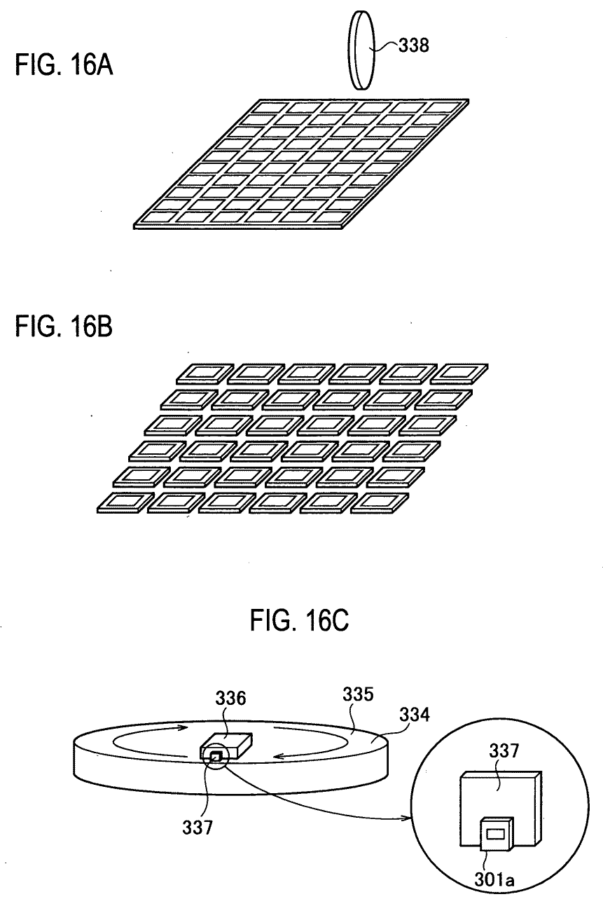

A description is given of a method of manufacturing the light emitting element 2A according to a fourth embodiment of the present invention with reference to FIG. 16. The light emitting element 2A according to the fourth embodiment has a same configuration as that of the light emitting element 2A described in the third embodiment, and the redundant description thereof is omitted.

First, the substrate 302 which is composed of a single crystal of GaN and is about 300 μm thick is prepared. Herein, the surface 302a of the substrate 302 is non-polar m-plane. Subsequently, the light emitting section 303 is epitaxially grown on the surface 302a of the above substrate 302 by MOCVD.

The first electrode section 304 of ZnO is then formed on the entire surface 315a of the second semiconductor layer 315 by sputtering or vacuum vapor deposition.

By forming a desired resist pattern and etching the first electrode section 304 and light emitting section 303, a part of the semiconductor layer 311 is mesa-etched to expose the surface of the electrode. In the exposed surface of the electrode, Ti and Al layers are sequentially stacked by vacuum vapor deposition such as resistance heating deposition or electron beam deposition, thus forming the second electrode 306.

As shown in FIG. 16A, the obtained product is diced into element units using a tool cutting wafers such as a dicing plate. By dicing, the substrate can be divided into the element units as shown in FIG. 16B.

The side face 301a of each divided element is rough because of the cutting by dicing. Accordingly, the entire side face 301a of the substrate 302 is polished and mirror-finished. Since the substrate 302 is as thin as about 100 μm, each divided element is attached to the dummy substrate 337 as shown in FIG. 16C, and the dummy substrate 337 with the element attached thereto is placed on the jig 336. The side face 301a of the substrate 302 is polished by the polisher 335 using the abrasive sheet 334 for mirror finishing of the side face 301a. Through the aforementioned process, the light emitting element 2A according to the fourth embodiment is completed.

In the aforementioned step of polishing the side face 301a, the abrasive sheet 334 is used. However, the polishing may be performed by CMP or by a combination of the abrasive sheet and CMP.

According to the light emitting element 2A according to the fourth embodiment of the present invention, the substrate is divided into the element units by dicing. Accordingly, the substrate is not necessarily thin, and the process of grinding the part of the substrate 302 on the rear surface 302b side by mechanical polishing can be omitted.

### Fifth Embodiment

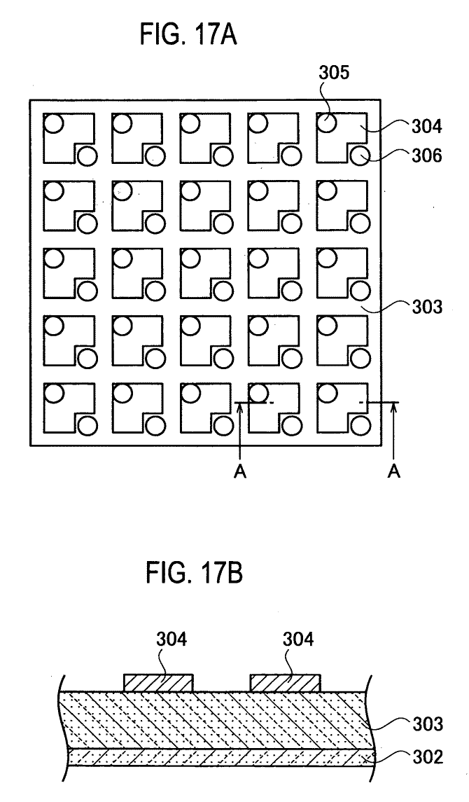

A description is given of a method of manufacturing the light emitting element 2A according to a fifth embodiment of the present invention with reference to FIGS. 17 to 20. The light emitting element 2A has a same configuration as that of the light emitting element 2A described in the third embodiment, and the redundant description thereof is omitted.

First, the substrate 302 which is composed of a single crystal of GaN and is about 300 μm thick is prepared. Herein, the surface 302a of the substrate 302 is the non-polar m-plane. Subsequently, the light emitting section 303 is epitaxially grown on the surface 302a of the above substrate 302 by MOCVD.

The first electrode section 304 of ZnO is then formed on the entire surface 315a of the second semiconductor layer 315 by sputtering or vacuum vapor deposition.

By forming a desired resist pattern and etching the first electrode section 304 and light emitting section 303, a part of the semiconductor layer 311 is mesa-etched to expose the surface of the electrode. In the exposed surface of the electrode, Ti and Al layers are sequentially stacked by vacuum vapor deposition such as resistance heating deposition or electron beam deposition, thus forming the second electrode 306.

Subsequently, part of the substrate 302 on the rear surface 302b side is ground by mechanical polishing so that the thickness of the substrate 302 is not more than about 100 μm. Herein, FIG. 17A shows a top plan view of the elements, and FIG. 17B shows a cross-sectional view taken along a line A-A of FIG. 17A.

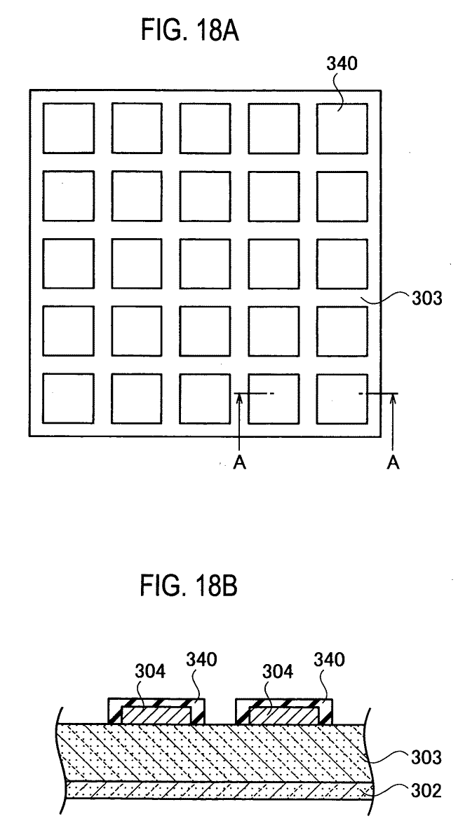

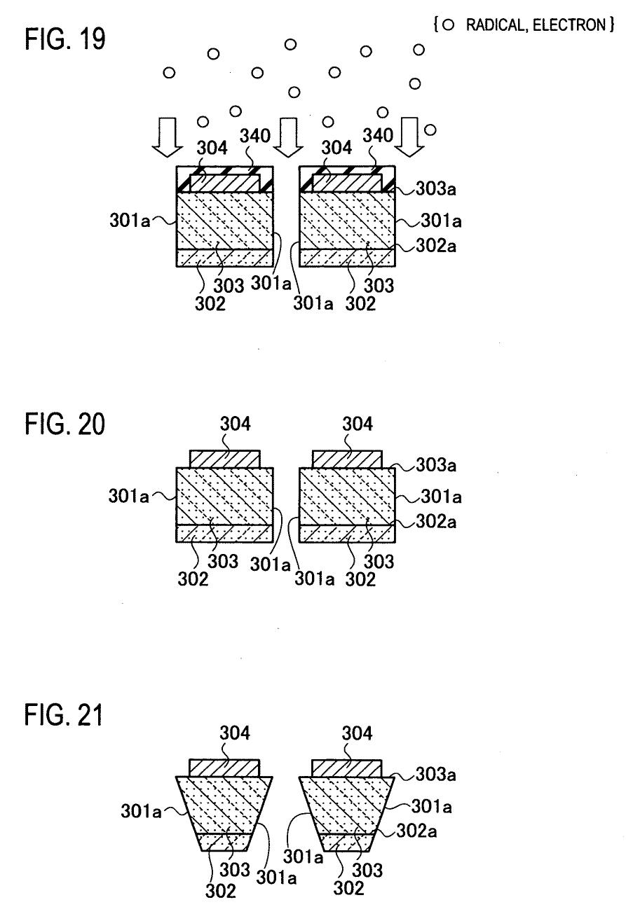

As shown in FIGS. 18A and 18B, a resist 340 is patterned on the elements to form grooves along which the elements are divided. The product provided with the resist 340 is placed within a vacuum vessel (not shown), and a reactive gas such as silicon tetrachloride (SiCl₄), chlorine (Cl₂), or the like is introduced to the vessel. The gas is then exited by a high frequency wave, a microwave, or the like to generate plasma and produce radicals, ions, electrons, and the like. As shown in FIG. 19, the light emitting section 303 and substrate 302, which are etching objects, are reacted with the radicals, ions, electrons, and the like produced by plasma and divided into element units. The side faces 301a formed by the division are mirror-finished by dry etching. As shown in FIG. 20, the resist patterns 340 are removed to complete the light emitting elements 2A according to the fifth embodiment.

According to the light emitting element 2A of the fifth embodiment of the present invention, the division into the element units and mirror finishing of the side faces 301a are simultaneously performed.

According to the light emitting element 2A of the fifth embodiment of the present invention, the elements are divided by dry etching and therefore divided at once.

For example, in the description of the third to fifth embodiments, the side faces 301a are orthogonal to the surfaces 302a of the substrates 302 and the surfaces 303a of the light emitting elements 303 but are not limited to this. As shown in FIG. 21, each side face 301a may have a taper angle with respect to the surface 302a of the substrate 302 and the surface 303a of the light emitting section 303. With the taper angle, part of light projected to the outside of the side face 301a is reflected on the side face 301a and goes towards the first electrode section 304, thus increasing the power of gathering light going towards the first electrode section 304. A method of forming the side face 301a which has a taper angle and is a mirror surface includes placing the jig 336 on the polisher 335 shown in FIGS. 13D and 16C at a desired angle for polishing. Another method thereof includes utilizing isotropic nature of wet etching.

Furthermore, in the description of the fifth embodiment, the method of dividing the light emitting element 2A into the element units is dry etching but may be wet etching.

### Sixth Embodiment

A sixth embodiment of the present invention describes an application of the present invention to a light emitting device which includes a light emitting diode (LED) as a light emitting element and has a surface mounting structure.

### [Configuration of Light Emitting Device]

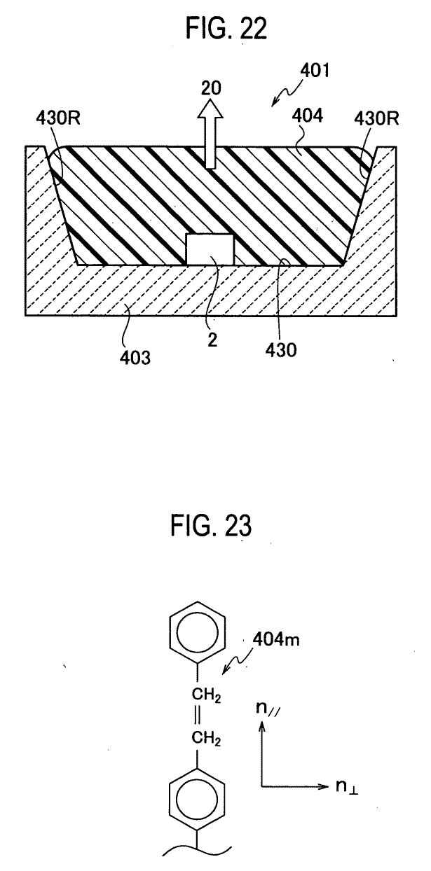

As shown in FIG. 22, a light emitting device 401 according to the sixth embodiment includes a light emitting element attachment module 403; the light emitting element 2 which is mounted on the light emitting element attachment module 403 and emits the polarized light 20; and a light transmitting resin section 404 which covers the light emitting element 2 and transmits the polarized light 20 emitted from the light emitting element 2. In the light transmitting resin section 404, resin molecules (404m) have a disordered structure.

The light emitting element attachment module 403 is a package substrate of a surface mounting structure in the sixth embodiment and includes a mounting surface 430 having a recessed cross-section and serving as a reflector 430R. The light emitting element 2 is mounted on a bottom surface of the mounting surface 430 of the light emitting element attachment module 403, and the reflector 430R is composed of a taper surface on the light emitting element attachment module 403 around the side faces of the light emitting element 2. The mounting surface 430 and reflector R are integrated.

### [Molecular Structure of Light Transmitting Resin Section]

In the light emitting device 401 according to the sixth embodiment, the resin molecules (404m) of the light transmitting resin section 404 have a disordered structure, and the light transmitting resin section 404 having the disordered structure does not develop birefringence. Herein, a birefringence Δn is defined as a difference between a refractive index nᵥ in a direction vertical to the molecular axes of the resin molecules 404m shown in FIG. 23 and a refractive index nₚ in a direction parallel to the molecular axes of the resin molecules 404m.

Δn=nᵥ−nₚ

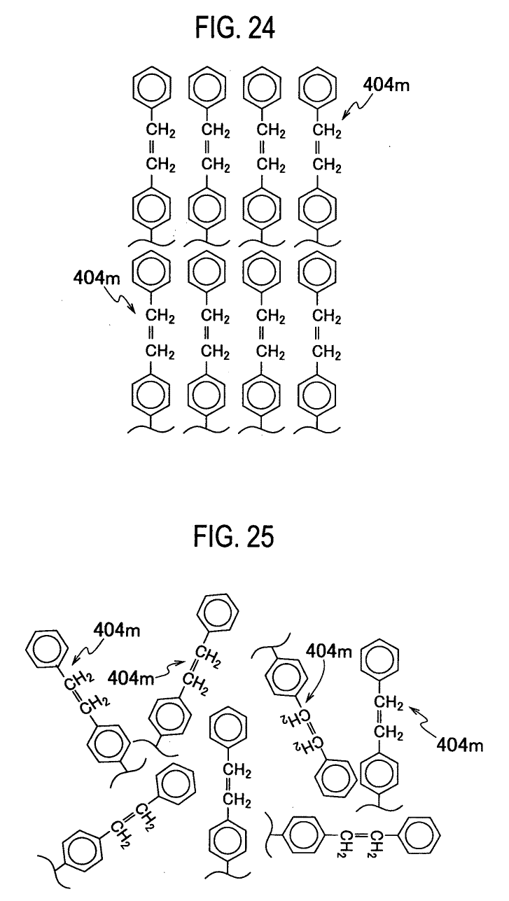

When the refractive indices nᵥ and nₚ are equal, there is no birefringence in the light transmitting resin section 404. When stress, heat, or the like is rapidly applied to the light transmitting resin section at the manufacturing process of the light transmitting resin section, the resin molecules 404m of the light transmitting resin section have an orientation as shown in FIG. 24. In other words, the molecular axes of the resin molecules 404m are regularly oriented in the same direction. In the light transmitting resin section with the resin molecules 404m oriented in the same direction, macroscopic birefringence is developed. On the other hand, in the light emitting device 401 according to the sixth embodiment, at the manufacturing process of the light transmitting resin section 404, at least applied stress is reduced, or rapid heating is reduced. Accordingly, the arrangement of the resin molecules 404m, or the directions of the molecular axes of the resin molecules 404m are randomly controlled. In the light transmitting resin section 404 including the resin molecules 404m having a disordered structure, no macroscopic birefringence is developed. Accordingly, the polarized light 20 emitted from the light emitting element 2 is not disturbed when being transmitted through the light transmitting resin section 404.

As described above, the sixth embodiment is provided with the light transmitting resin section 404 with the resin molecules 404m having a disordered structure. It is therefore possible to implement the light emitting device 401 capable of preventing dispersion of the polarized light emitted from the light emitting element 2.

### [Method of Manufacturing Light Emitting Device]

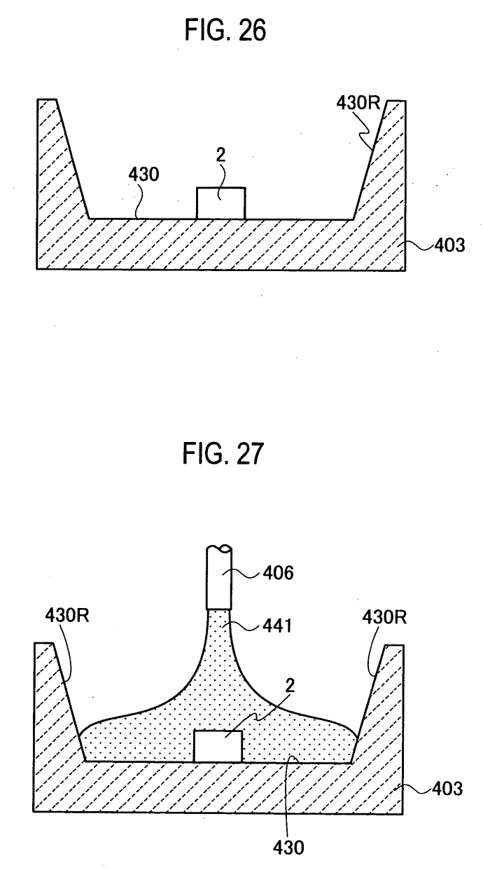

Next, a description is given of a method of manufacturing the light emitting device 401 according to the aforementioned sixth embodiment with reference to FIGS. 26 to 29. First, As shown in FIG. 26, the light emitting element 2 is mounted on the mounting surface 430 of the light emitting element attachment module 403 by die-bonding. The first and second electrodes 211 and 212 of the light emitting element 2 are electrically connected to electrodes provided for the mounting surface 430 of the light emitting element attachment module 403 just after the light emitting element 2 is mounted on the light emitting element attachment module 403 or thereafter.

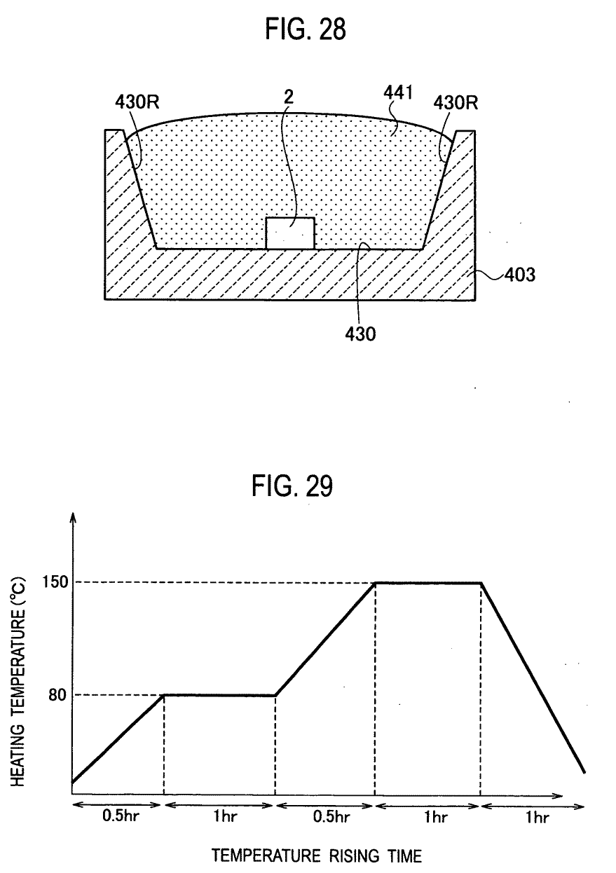

As shown in FIG. 27, using syringe dropping application, light transmitting resin 441 is dropped from a syringe 406 and applied to the light emitting element 2 mounted on the mounting surface 430 of the light emitting element attachment module 403. As shown in FIG. 28, the light emitting element 2 is covered with the light transmitting resin 441 to be resin-sealed by the light transmitting resin 441. In the light transmitting resin 441 formed by the syringe dropping application, the internal stress can be made less than that formed by molding of mold resin such as injection molding or extrusion molding.

Subsequently, as shown in FIG. 29, the temperature of the light transmitting resin 441 dropped and applied is raised stepwise to harden the light transmitting resin 441, thus forming the light transmitting resin section 404. Herein, FIG. 29 shows temperature data of the temperature increasing method that the applicants actually performed for general sealing resin. In the drawing, the horizontal axis indicates temperature rising time (hours), and vertical axis indicates heating temperature (° C.). In this stepwise temperature increasing method, first heating for hardening of the light transmitting resin 441 is started, and the heating temperature is linearly raised from the room temperature to 80° C. for 0.5 hours. During the following 1.0 hour, the heating temperature is maintained constant at 80° C. The heating temperature is then linearly raised from 80° C. to the maximum heating temperature of 150° C. within 0.5 hours and is then maintained constant at 150° C. for 1 hour. Thereafter, the temperature is linearly reduced from 150° C. to room temperature. According to the applicants, after actually using the stepwise temperature increasing method, birefringence is not developed in the hardened light transmitting resin section 404.

In the method of manufacturing the light emitting device 401 according to the sixth embodiment, the light transmitting resin section 404 covering the light emitting element 2 is formed by the dropping application, and the light transmitting resin section 404 is hardened by the stepwise temperature increasing method. It is therefore possible to prevent dispersion of the polarized light 20 emitted from the light emitting element 2.

### Seventh Embodiment

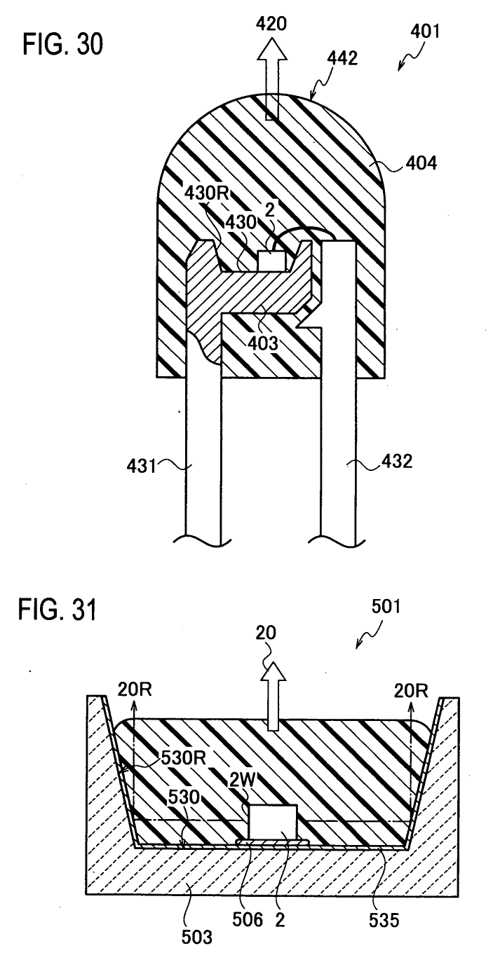

A seventh embodiment of the present invention is an application of the present invention to a light emitting device having a shell-type package structure instead of the light emitting device 401 having the surface mounting structure according to the aforementioned sixth embodiment. As shown in FIG. 30, the light emitting device 401 according to the seventh embodiment includes the light emitting element attachment module 403; the light emitting element 2 which is mounted on the light emitting element attachment module 403 and emits the polarized light 20; and the light transmitting resin section 404 covering the light emitting element 2 and transmitting the polarized light 20 emitted from the light emitting element 2. The light transmitting resin section 404 has the resin molecules (404m) having the disordered structure.

In the seventh embodiment, the light emitting element attachment module 403 is provided at an end of a lead 431 and is integrated with the lead 431. The lead 431 is used as a cathode electrode in the seventh embodiment. The basic configuration of the light emitting element attachment module 403 is the same as that of the light emitting device 401 according to the aforementioned sixth embodiment and includes the mounting surface 430 having a recessed cross-section and serving as the reflector 430R. The light emitting element 2 is mounted on the bottom surface of the mounting surface 430 of the light emitting element attachment module 403. Around the side faces of the mounted light emitting element 2, the reflector 430R composed of a taper surface is provided on the light emitting element attachment module 403. In an area adjacent to the lead 431, a lead 432 is provided. The lead 432 is used as an anode electrode, and an end of the lead 432 (no reference numeral) is electrically connected to the light emitting element 2 through a wire.

The light transmitting resin section 404 covers the light emitting element attachment module 403 at the end of the lead 431 and the end of the lead 432 and includes a semispherical lens section 442 above the light emitting element 2, that is, in an area through which the polarized light 20 from the light emitting element 2, is emitted. In the light transmitting resin section 404, the resin molecules 404m is configured to have a disordered structure and prevent development of birefringence like the light transmitting resin section 404 of the light emitting device of the aforementioned sixth embodiment.

The thus-configured light emitting device 401 according to the seventh embodiment can provide the same effect as that obtained from the light emitting device 401 according to the aforementioned sixth embodiment.

For example, in the description of the light emitting devices 4 of the sixth and seventh embodiments, the light transmitting resin section 404 is assumed to be transparent. However, the light transmitting resin section 404 is not necessarily transparent and may be composed of light transmitting resin mixed with a dye of blue, green, red, orange, or the like.

Moreover, the light emitting element 2 may be replaced with the light emitting element 2A.

### Eighth Embodiment

An eighth embodiment of the present invention describes an application of the present invention to a light emitting device including an LED as a light emitting element and having a surface mounting structure.

### [Configuration of Light Emitting Device]

As shown in FIG. 31, a light emitting device 501 according to the eighth embodiment includes the light emitting element 2 which emits the polarized light 20 and whose surface 2W is a mirror surface; and a light emitting element attachment module 503 on which the light emitting element 2. At least a part of the inner surface on which the light emitting element 2 is mounted is a mirror surface. Furthermore, the light emitting device 501 includes a light transmitting resin section 504 which covers the light emitting element 2 and transmits the polarized light 20 emitted from the light emitting element 2.

### [Configuration of Light Emitting Element Attachment Module]

In the eighth embodiment, the light emitting element attachment module 503 is a package substrate of a surface mounting structure and includes a mounting surface 530 having a recessed cross-section and serving as a reflector 530R. The light emitting element 2 is mounted on a bottom surface of the mounting surface 530 of the light emitting element attachment module 503, and the reflector 530R is composed of a taper surface on the light emitting element attachment module 503 around the side faces of the light emitting element 2. The mounting surface 530 and reflector 530R are integrated. In the eighth embodiment, the light emitting element attachment module 503 can be made of ceramic such as AlN or Al₂O₃ for practical use, and the ceramic is produced by baking.

The inner surface of the light emitting element attachment module 503 where the light emitting element 2 is mounted, or the mounting surface 530 and reflector 530R are provided with a metal coating surface 535, which is a mirror surface. The light emitting element 2 is electrically and mechanically connected to the mounting surface 530 with a conductive bonding material 506 interposed therebetween. The bonding material 506 is practically for example silver (Ag) paste.

Herein, the term “mirror surface” is used to mean a reflecting surface which is capable of reducing diffusive reflection of not only the polarized light 20 emitted from the surface of the light emitting element 2 facing the irradiated surface but also polarized light 20R emitted from the surface 2W and rear surface of the light emitting element 2 and does not disturb the polarization property of the polarized light 20. To be specific, a surface having a surface roughness of not more than a fourth of wavelength of the polarized light 20R emitted from the light emitting element does not cause diffusive reflection of the polarized light 20R reflected on the same. For example, when the wavelength of the polarized light 20R emitted from the light emitting element 2 is 400 nm, the surface roughness of the metal coating surface 535 is set not more than 100 nm.

In the eighth embodiment, the metal coating surface 535 is practically an aluminum (Al) or Ag metallic thin film with a high reflectivity which is formed by electroplating. These metallic thin films are formed to have thicknesses of several hundreds to several micrometers, for example. The method of forming the metallic thin film can be another method such as deposition, sputtering, or the like.

### [Light Transmitting Resin Section]

In the light transmitting device 501 according to the eighth embodiment, the light transmitting resin section 504 shown in FIG. 31 fills a recessed portion defined by the mounting surface 530 and reflector 530R and covers the light emitting element 2. The light transmitting resin section 504 transmits the polarized light 20 emitted from the surface of the light emitting element 2 and the polarized light 20R which is emitted from the surface 2W and rear surface and reflected on the reflector 530R. The light transmitting resin section 504 can be practically made of any one of silicone resin and epoxy resin, for example. In the eighth embodiment, the material of the light transmitting resin section 504 is not limited to these resin materials.

In the thus-constituted light emitting device 501 according to the eighth embodiment, the inner surface of the light emitting element attachment module 503 on which the light emitting element 2 is mounted is a mirror surface. Accordingly, the diffusive reflection of the polarized light 20R emitted from the surfaces 2W and rear surface of the light emitting element 2 can be reduced, and the polarized light 20 can be prevented from being diffused. Furthermore, in the light emitting device 501 according to the eighth embodiment, the surface 2W of the light emitting element 2 is a mirror surface, so that the diffusive reflection of the polarized light 20R on the surface 2W can be reduced, and the diffusion of the polarized light 20 can be reduced.

### Ninth Embodiment

A ninth embodiment of the present invention describes an application of the present invention to a light emitting device having a shell-type package structure instead of the light emitting device 501 having the surface mounting structure according to the aforementioned eighth embodiment.

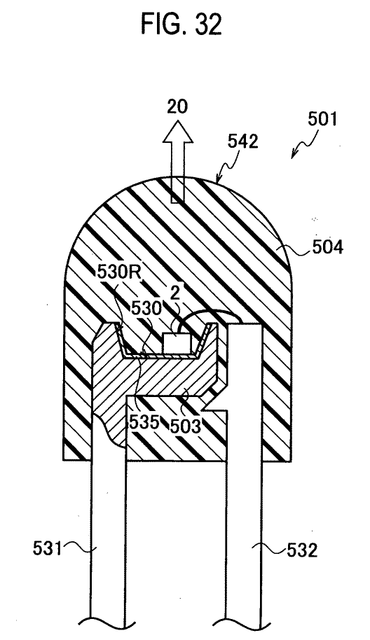

As shown in FIG. 32, the light emitting device 501 according to the ninth embodiment includes the light emitting element 2 which emits the polarized light 20 and whose surface 2W is the mirror surface; and the light emitting element attachment module 503 on which the light emitting element 2 is mounted. The inner surface of the light emitting element attachment module 503 is the mirror surface. The light emitting device 501 further includes the light transmitting resin section 504 covering the light emitting element 2 and transmitting the polarized light 20 emitted from the light emitting element 2.

In the ninth embodiment, the light emitting element attachment module 503 is provided at an end of a lead 531 and is integrated with the lead 531. The lead 531 is used as a cathode electrode in the ninth embodiment. The basic configuration of the light emitting element attachment module 503 is the same as that of the light emitting device 501 according to the aforementioned eighth embodiment and includes the mounting surface 530 having a recessed cross-section and serving as the reflector 530R. The light emitting element 2 is mounted on the bottom surface of the mounting surface 530 of the light emitting element attachment module 503. Around the side faces of the mounted light emitting element 2, the reflector 530R composed of a taper surface is provided on the light emitting element attachment module 503. A metal coating surface 535 is provided on the inner surface of the light emitting element attachment module 503 on which the light emitting element is mounted, or on the mounting surface 530 and reflector 530R in the same manner as the light emitting element attachment module 503 of the light emitting device 501 according to the aforementioned eighth embodiment.

In an area adjacent to the lead 531, a lead 532 is provided. The lead 532 is used as an anode electrode, and an end of the lead 532 is electrically connected to the light emitting element 2 through wire (no reference number).

The light transmitting resin section 504 covers the light emitting element attachment module 503 at the end of the lead 531 and the end of the lead 532 and includes a semispherical lens section 542 above the light emitting element 2 or in an area through which the polarized light 20 from the light emitting element 2 is emitted. The light transmitting resin section 504 can be practically made of any one of silicone resin and epoxy resin like the light transmitting resin section 504 of the light emitting device 501 according to the aforementioned eighth embodiment.

The thus-configured light emitting device 501 according to the ninth embodiment can provide the same effect as that obtained from the light emitting device 501 according to the aforementioned eighth embodiment. Moreover, the light emitting device 501 according to the ninth embodiment is not limited to the aforementioned description. For example, the light emitting element 2 can be replaced with the light emitting element 2A.

Hereinabove, the present invention is described based on the above embodiment, but the description and drawings constituting a part of the disclosure do not limit the present invention. The present invention includes various embodiments and the like not described herein. Accordingly, the technical scope of the present invention is determined only by the invention specifying matters according to claims reasonable based on the above description.

For example, some of the embodiments may be combined, and the configuration of the combination is included in embodiments of the present invention.

What is claimed is:

1. A light emitting device, comprising:
a light emitting element emitting light having polarization characteristics; and
a light emitting element attachment module, with respect to a plane of incidence onto a reflecting surface which reflects the light emitted from the light emitting element, allowing a polarization direction of the incident light to be set more than −45 degrees and less than +45 degrees.

2. The light emitting device according to claim 1, wherein
the polarization direction of the incident light emitted from the light emitting element is set parallel to the plane of incidence.

3. The light emitting device according to claim 1, wherein
the light emitting element is composed of a group III nitride semiconductor having a non-polar or semi-polar main surface and includes: a substrate; a first semiconductor layer of a first conductive type on the substrate; a light emitting layer on the first semiconductor layer; and a second semiconductor layer of a second conductive type on the light emitting layer.

4. The light emitting device according to claim 1, wherein
the light emitting device is incorporated to a taillight of a vehicle.

5. The light emitting device according to claim 1, wherein
the light emitting device is incorporated to a headlight of a vehicle.

6. The light emitting device according to claim 1, wherein
the reflecting surface is a screen of a display unit and the light emitting device is lighting equipment lighting the screen of the display unit or a light emitting device incorporated in the lighting equipment.

7. The light emitting device according to claim 3, wherein
a side face is a mirror surface.

8. The light emitting device according to claim 3, wherein
the substrate is composed of GaN.

9. The light emitting device according to claim 3, wherein
a main growth surface of the group III nitride semiconductor is m-plane.

10. The light emitting device according to claim 3, wherein
the substrate has a thickness of not more than 100 μm.

11. The light emitting device according to claim 3, wherein
the side face has a taper angle to the main growth surface.

12. The light emitting device according to claim 1, further comprising:
a light transmitting resin section covering the light emitting element, transmitting the polarized light emitted from the light emitting element, and including resin molecules in a disordered structure.

13. The light emitting device according to claim 12, wherein
the light transmitting resin section includes the resin molecules randomly located.

14. The light emitting device according to claim 12, wherein
the light transmitting resin section has a refractivity in a direction vertical to molecular axis of the resin molecules and a refractivity in a direction parallel to the molecular axis, and the two refractivities are equal to each other.

15. The light emitting device according to claim 1, wherein
in the light emitting element attachment module, a part of an inner surface on which the light emitting element is mounted is composed of a mirror surface.

16. The light emitting device according to claim 15, wherein
the inner surface of the light emitting element attachment module includes a mounting surface on which the light emitting element is mounted and a reflector reflecting the polarized light emitted from the light emitting element, and
the mounting surface and the reflector are composed of a mirror surface.

17. The light emitting device according to claim 15, wherein
the mirror surface is a surface, a roughness of which of the inner surface or the mounting surface and the reflector set to not more than one fourth of wavelength of the polarized light emitted from the light emitting element.

18. The light emitting device according to claim 15, wherein
the mirror surface is a surface, a roughness of which of the inner surface or the mounting surface and the reflector set to not more than 100 nm.

19. The light emitting device according to claim 1, wherein
in the light emitting element, a side face is a mirror surface, and
in a light emitting element attachment module, at least a part of the inner surface on which the light emitting element is mounted is a mirror surface.

20. A method of manufacturing a light emitting device, the method comprising the steps of:
mounting a light emitting element emitting polarized light on a light emitting element attachment module; and
dropping and applying light transmitting resin onto the light transmitting element to form a light transmitting resin section covering the light emitting element, the light transmitting resin transmitting polarized light emitted from the light emitting element.

21. A method of manufacturing a light emitting device, the method comprising the steps of:
mounting a light emitting element emitting polarized light on a light emitting element attachment module;
dropping and applying light transmitting resin onto the light transmitting element, the light transmitting resin transmitting polarized light emitted from the light emitting element; and
increasing temperature of the light transmitting resin stepwise and hardening the light transmitting resin to form a light transmitting resin section covering the light emitting element.
